(19) United States
(12) Patent Application Publication
(10) Pub. No.: US 2015/0306830 A1
(43) Pub. Date: Oct. 29, 2015

(54) METHOD AND PLANT FOR BUILDING TYRES FOR VEHICLE WHEELS

(71) Applicant: PIRELLI TYRE S.P.A., Milano (IT)

(72) Inventors: Maurizio MARCHINI, Milan (IT); Albert BERENGUER, Milan (IT)

(73) Assignee: Pirelli Tyre S.p.A., Milan (IT)

(21) Appl. No.: 14/651,100

(22) PCT Filed: Nov. 28, 2013
(86) PCT No.: PCT/IB2013/060473

§ 371 Date: Jun. 10, 2015

Related U.S. Application Data
(60) Provisional application No. 61/746,974, filed on Dec. 28, 2012.

(30) Foreign Application Priority Data
Dec. 21, 2012 (IT) MI2012A002214

(51) Int. Cl. B29D 30/00; B29D 30/08

(52) U.S. Cl. CPC B29D 30/005; B29D 30/0016; B29D 30/08

(57) ABSTRACT

Tyres are processed while simultaneously passing along a building line, each tyre to be subjected to a plurality of processes, each in a respective work station. At least one first and one second tyre reach a work area at different times, stay in the work area simultaneously in respective work stations adapted to perform respective homologous processes on the tyres, and leave the work area at different times. The tyres stay respectively in at least one first work station and at least one second work station, both integrated in the work area. The first tyre passes through the work area without staying in the second work station, and the second tyre passes through the work area without staying in the first work station.

The present invention has as object a method and a plant for building tyres for vehicle wheels.

A tyre for vehicle wheels generally comprises a carcass structure comprising at least one carcass ply having respectively opposite terminal ends engaged with respective annular reinforcing structures, generally termed “bead cores”, integrated in the zones usually identified with the name of “beads”, having an internal diameter substantially corresponding with a so-called “fitting diameter” of the tyre on a respective mounting rim. The tyre further comprises a crown structure comprising at least one belt strip situated in radially outer position with respect to the carcass ply and one tread band radially external with respect to the belt strip. Between the tread band and the belt strip(s), a so-called “underlayer” can be interposed made of elastomeric material with properties suitable for ensuring a stable union of the belt strip(s) with the tread band itself. On the lateral surfaces of the carcass structure, each extending from one of the lateral edges of the tread band up to the respective annular anchoring structure to the beads, respective sidewalls made of elastomeric material are also applied. In the tyres of “tubeless” type, the carcass ply is internally covered by a layer of elastomeric material, preferably with butyl base, usually termed “liner” having optimal characteristics of impermeability to the air and being extended from one bead to the other.

WO 2008/043382, on behalf of the same Applicant, describes a process and a line for producing tyres in which a first toroidal support is transferred to a first assembly apparatus by means of which a first toroidal carcass ply and a first pair of annular reinforcement inserts, each associated with a respective radially inner edge of the first toroidal carcass ply, are sequentially built on the toroidal support. The first toroidal support is transferred to a second assembly apparatus by means of which a second toroidal carcass ply and a second pair of annular reinforcement inserts, each associated with a respective radially inner edge of the second toroidal carcass ply, are sequentially built on the toroidal support. A second toroidal support is transferred to the first assembly apparatus during the construction of the second carcass ply on the first toroidal support.

WO 2009/040594, on behalf of the same Applicant, describes a plant and a process for building tyres in which carcass structures are built on a first building drum along a carcass building line, whereas along a crown building line, crown structures are build, each on a second and a third building drum. The building drums circulate between the work stations consecutively aligned along the carcass building line and along the crown building line.

In a shaping and assembly station, synchronised with the carcass building line and the crown building line, each carcass structure is shaped according to a toroidal configuration and coupled to a crown structure.

Each carcass structure remains associated with the respective first building drum on which it is built, until the end of the assembly with the respective crown structure.

By “cycle time”, it is intended the time elapsed during operation from the end of the building of one tyre to the building of the next tyre. More precisely, in the context of plants having a plurality of work stations, the cycle time coincides with the time it takes a tyre being processed to cross the slowest work station. By “crossing” it is intended the overall time employed by said tyre being processed for entering into the aforesaid work station, carrying out the processing which the work station is set to perform and exiting from such station.

By “homologous processes” it is intended processes which determine the formation of components corresponding with regard to position and structural shape and arranged to perform the same functions, on at least one first and one second tyre being processed. For example, processes that give rise to a first belt layer (or to a first carcass ply), respectively in a first and second tyre, are homologous processes. However, processes that give rise to a first belt layer (or to a first carcass ply) on the first tyre and to a second belt layer (or to a second carcass ply) on the second tyre are not homologous processes.

By “tyre being processed” it is intended any one tyre portion, intended to be associated with other components for the purpose of attaining the finished green tyre.

The Applicant has observed that in the building plants of the type illustrated in WO 2009/040594, the transfer of the tyres being processed from one work station to the subsequent work station must occur according to a predetermined frequency, falling within a pre-established cycle time.

The Applicant nevertheless deems that in order to improve the efficiency of the building plants and the quality of the finished product, it would be advantageous to be able to provide more time for performing certain processes with greater accuracy. More particularly the Applicant deems it advantageous to provide more time for the processes used at least for the building of belt layers, carcass plies and tread band, without modifying the cycle time of the building plant.

The Applicant has perceived that by arranging, along the building line of a plant, one or more zones that enclose at least two work stations, in which each of said at least two work stations is set for the same building of components of the tyre being processed, even the most complex processes could be carried out without affecting the cycle time of the plant. More precisely, the Applicant has finally found that by arranging along the building line one or more work areas provided with two or more work stations adapted to perform homologous processes, partly simultaneously, each on a respective tyre being processed, it is possible to increase the time available for the performance of such processes, without having to increase the cycle time. More particularly, it becomes possible to assign a same work station with two or more processes, which would otherwise require the transfer of the tyre between two separate successive stations; thus the dead times are eliminated that would otherwise be required for transferring the tyre being processed from one station to the next. In other words, in the work area, two or more tyres being processed can each remain in a respective work station during the performance of two or more processes for a time substantially equivalent to a multiple of the cycle time, whereas the entrance/exit frequency of the tyres from the work area occurs in accordance with the cycle time.

More particularly, according to a first aspect the present invention relates to a method for building tyres, wherein a plurality of tyres being processed simultaneously pass along a building line, each tyre to be subjected to a plurality of processes, each in a respective work station.

Preferably along the building line at least one first and one second tyre being processed reach a work area at different times according to an input sequence, stay in the work area, simultaneously in respective work stations adapted to perform respective homologous processes on said tyres being processed, and leave the work area at different times.

Preferably the first and the second tyre being processed stay respectively in at least one first and at least one second work station in the work area.

Preferably the first tyre passes through the work area without staying in said at least one second work station, and the second tyre passes through the work area without staying in said at least one first work station.

The Applicant deems that in such a manner the work stations installed in the work area can thus be used for the performance of complex processes, with greater processing times than those required by the other work stations outside the work area, without slowing the operating frequency of the plant. In particular, in a same work station inside the work area, processes can be performed that would normally require the use of two or more work stations of the type installed outside the work area—with consequent reduction or elimination of the dead times that would otherwise be required for transferring the tyre being processed from one work station to the subsequent work station. More time is therefore available for the purpose of processes in the work area, enhancing the performance accuracy and the quality of the final product.

In accordance with a further aspect, the present invention relates to a plant for building tyres, comprising a plurality of work stations distributed in sequence along a building line.

Preferably, transfer devices are provided for transferring tyres being processed between successive work stations.

Preferably, the plant further comprises at least one work area wherein at least one first and at least one second of said work stations perform simultaneously homologous processes with respect to each other, respectively on a first and a second tyre being processed, respectively consecutive along the building line.

Preferably, said transfer devices transfer the first and the second tyre through the work area without staying the first tyre in said at least one second work station, and without staying the second tyre in said at least one first work station.

In one or more of the aforesaid aspects, the invention can advantageously comprise one or more of the preferred characteristics indicated hereinbelow.

Preferably, the first tyre is picked up from a work station upstream of the work area and transferred to said at least one first work station, and the second tyre is picked up from the work station upstream of the work area and transferred to said at least one second work station.

Preferably, the tyres being processed leave the work area according to an output sequence identical to the input sequence.

Upon reaching the respective work stations integrated in the work area, each of the tyres being processed preferably carries the same components.

Preferably, in the work area, each of the tyres being processed remains in a respective work station integrated in the work area according to a period of time greater than a period of stay of each tyre in work stations outside the work area.

Preferably, said tyres being processed are simultaneously moved through work stations distributed in sequence along the building line.

Preferably, the second tyre being processed which reaches the work area is loaded in the second work station downstream of the first work station carrying the first tyre previously introduced into the work area.

Preferably, two tyres being processed simultaneously stay in the work area during the performance of part, respectively initial and final, of the respective processes.

Therefore, a greater or complete operative saturation of all the work stations comprised in the work area is made possible.

Preferably, each of the tyres being processed in the work area remains in a respective work station integrated in the work area according to a period of time substantially equivalent to a multiple of a period of stay of each tyre in work stations outside the work area.

Preferably, each tyre crosses the work area in a crossing time substantially equivalent to n times a crossing time of at least one work station outside the work area, where n is the number of work stations integrated in the work area.

Preferably, in the work area, each of the tyres stays in a respective work station integrated in the work area.

Preferably the processing of each tyre in the respective work station integrated in the work area comprises the application of two or more components of said tyre.

Preferably, in each of the work stations integrated in the work area there is performed the application of a first belt layer and a second belt layer of a tyre being processed.

Preferably, in each of the work stations integrated in the work area there is performed the application of a first carcass ply and a second carcass ply of a tyre being processed.

Preferably, in each of the work stations integrated in the work area there is performed the application of a first and a second portion of a tread band of a tyre being processed.

Preferably, said transfer devices pick up the first tyre coming from a work station upstream of the work area for transferring it to said at least one first work station, and pick up the second tyre coming from the work station upstream of the work area for transferring it to said at least one second work station.

Preferably, the transfer devices pick up the first and the second tyre being processed from the work area according to an output sequence identical to an input sequence of the same tyres in the work area.

Preferably, the work stations integrated in said work area are aligned along the building line.

Preferably, the work stations integrated in said work area are arranged symmetrically with respect to a direction of alignment between a position for the input and a position for the output of the tyres being processed from the work area.

Preferably, the work stations integrated in said work area, are arranged laterally with respect to a direction of alignment between a position for the input and a position for the output of the tyres being processed from the work area.

Preferably, each work station integrated in the work area comprises devices for applying a first and a second component of said tyre being processed.

Preferably, each work station integrated in the work area comprises devices for applying a first belt layer and a second belt layer of said tyre being processed.

Preferably, each work station integrated in the work area comprises devices for applying a first carcass ply and a second carcass ply of said tyre being processed.

Preferably, each work station integrated in the work area comprises devices for applying a first and a second portion of a tread band of said tyre being processed.

Further characteristics and advantages will be clearer from the detailed description of a preferred but not exclusive embodiment of a method and a plant for building tyres for vehicle wheels, in accordance with the present invention.

Such description will be set forth hereinbelow with reference to the set of drawings, provided only for exemplifying and thus non-limiting purposes, in which:

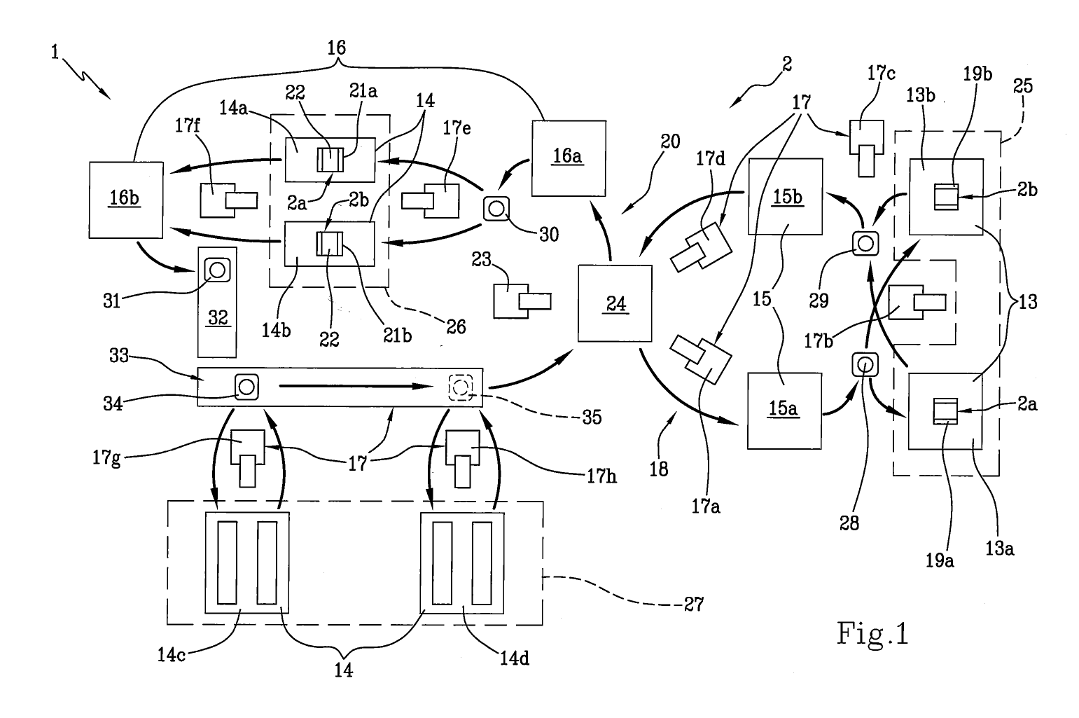

FIG. 1 shows a schematic lay-out of a plant for building tyres obtained according to the present invention;

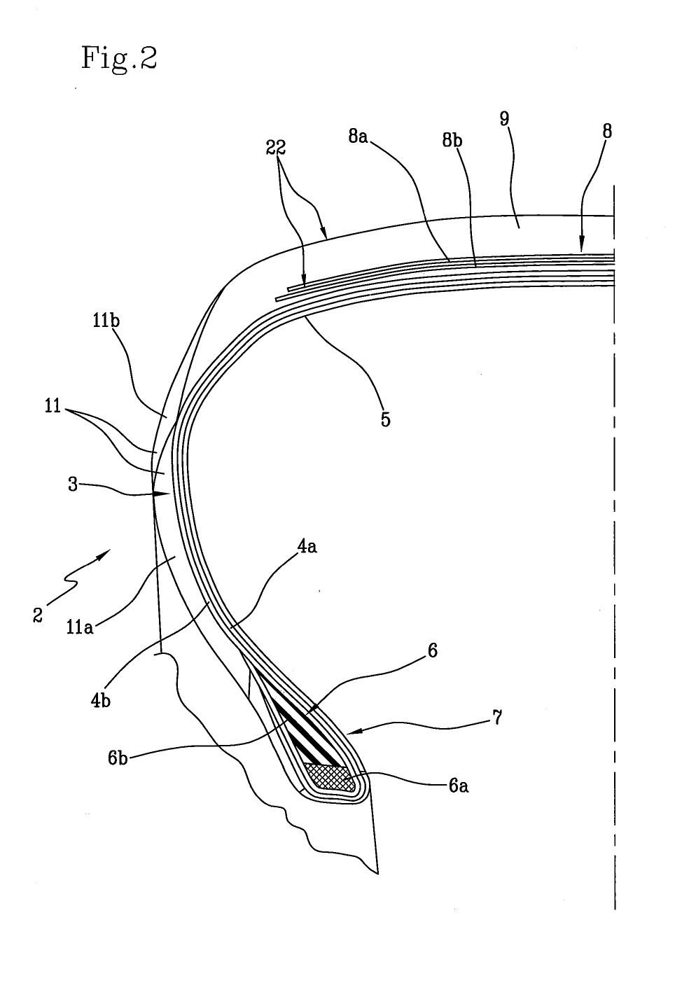

FIG. 2 schematically shows a cross section view of a tyre obtainable in accordance with the present invention.

With particular reference to FIG. 1, reference number 1 indicates a plant for building tyres of vehicle wheels, in accordance with the present invention and in its entirety.

A complete tyre 2, obtainable by the plant 1 and the method in accordance with the present invention, is exemplified in FIG. 2 and essentially comprises a carcass structure 3 having two carcass plies 4a, 4b. An impermeable elastomeric material layer or so-called liner 5 is applied inside the carcass ply/plies 4a, 4b. Two annular reinforcing structures 6, each comprising a so-called bead core 6a carrying an elastomeric filler 6b in radially outer position, are engaged with respective terminal ends of the carcass plies 4a, 4b. The annular reinforcing structures 6 are integrated in proximity to zones usually identified with the name of “beads” 7, at which the engagement between the tyre 2 and a respective mounting rim usually occurs. A belt structure 8 comprising multiple belt layers 8a, 8b is circumferentially applied around the carcass plies 4a, 4b, and a tread band 9 is circumferentially superimposed on the belt structure 8. The tread band 9 can comprise (not illustrated) a base portion applied on the belt structure and a top portion applied in radially outer position around the base portion.

From each bead 7 at a corresponding lateral edge of the tread band 9, a sidewall is extended, possibly consisting of a radially inner portion 11a and a radially outer portion 11b, applied in axially outer position on the carcass plies 4a, 4b.

The plant 1 comprises a building line 12, along which a plurality of tyres being processed 2a, 2b moves.

The building line 12 has a plurality of work stations 13, 14, 15, 16 distributed in sequence. Robotised arms 17 (preferably of anthropomorphic type) and/or transfer devices of other type provide for simultaneously moving multiple tyres being processed 2a, 2b in order to transfer them between the work stations 13, 14, 15, 16 distributed in sequence along the building line 12, as indicated by the arrows without reference numbers in FIG. 1.

Each of the tyres being processed 2a, 2b which move along the building line 12 is therefore simultaneously subjected to respective processes, each in a respective work station 13, 14, 15, 16.

More particularly, along the building line 12, a carcass structure building path 18 can be defined, at which the building drums 19a, 19b, each carrying one of the tyres being processed 2a, 2b, are moved between different carcass work stations 13, 15. Such stations are arranged to form, on each building drum 19a, 19b, the carcass structure comprising at least the liner 5, the carcass ply or plies 4a, 4b, the annular reinforcement structures 6 and, possibly, at least the radially inner portion 11a of the sidewalls 11, by “radially inner” it being intended the sidewall portion closest to the bead 7 in the built tyre 2.

Simultaneously, along a crown structure building path 20, one or more auxiliary drums 21a, 21b are sequentially moved between respective crown work stations 14, 16. The crown work stations 14, 16 are adapted to form, on each auxiliary drum 21a, 21b, a crown structure 22 comprising at least the belt structure 8. Preferably, the crown structure 22 further comprises the tread band 9 and, possibly, at least the radially outer portion 11b of the sidewalls 11, by “radially outer” it being intended the sidewall portion closest to the tread band 9 in the completed tyre 2.

A handling device 23 associated with the crown structure building path 20 provides for transferring, to an assembly unit 24, each auxiliary drum 21a, 21b with the crown structure 22 formed thereon, making up part of the respective tyre being processed 2a, 2b. The assembly unit 24 for example arranges each crown structure 22, previously removed from the respective auxiliary drum 21a, 21b, around a respective building drum 19a, 19b carrying the carcass structure 3 built thereon, in order to determine the mutual coupling between the carcass structure 3 and the crown structure 22.

In the assembly unit 24, devices for removing the complete tyre 2 from the building drum 19a, 19b can also operate, so that the tyre is transferred to at least one moulding and curing unit, not illustrated.

Along the building line 12, i.e. along the carcass structure building path 18 and/or along the crown structure building path 20, one or more work areas 25, 26, 27 are present; in each work area, at least one first 13a, 14a, 14c and at least one second 13b, 14b, 14d of said work stations 13, 14 are integrated.

More particularly, in the illustrated exemplifying embodiment, a plurality of work areas 25, 26, 27 are provided, separate from each other: a ply deposition area 25 operates along the carcass structure building path 18 and integrates a first and a second ply work station 13a, 13b, comprising each devices for applying the first carcass ply 4a and the second carcass ply 4b; a belt deposition area 26 operates along the crown structure building path 20 and integrates a first and a second work station belt layers 14a, 14b, each comprising devices for applying the first belt layer 8a and the second belt layer 8b; a tread band 27 deposition area operates along the crown structure building path 20, and integrates a first and a second tread band work station 14c, 14d, each comprising devices for applying a first and a second portion of the tread band 9 on each tyre being processed 2a, 2b. Each of these work areas 25, 26, 27 can be present even in the absence of one or more of the others, coupled with one or more of the external work stations 15, 16, i.e. not integrated with the same work areas 25, 26, 27.

The work stations 13, 14, integrated in a same work area 25, 26, 27, perform simultaneously homologous processes with respect to each other, respectively on a first and a second tyre being processed 2a, 2b, following each other along the building line 12. Therefore, upon reaching the respective work stations 13, 14, in the work area, each of the tyres being processed 2a, 2b preferably carries the same components, applied in the course of the preceding processes.

Upon action of the robotised arms 17 or other transfer devices, the first and the second tyre being processed 2a, 2b reach the work area 25, 26, 27 at different times according to an input sequence, simultaneously stay in the work area 25, 26, 27, each in a respective work station 13, 14 integrated in the same area, and leave the work area at different times, preferably with an output sequence identical to the input sequence.

More particularly, the robotised arms 17 or other transfer devices transfer the first and the second tyre 2a, 2b through the respective work area 25, 26, 27, without staying the first tyre 2a in the second work station 13b, 14b, 14d, and without staying the second tyre 2b in the first work station 13a, 14a, 14c. Each tyre is therefore induced to cross the work area 25, 26, 27 without staying in the work station 13, 14, dedicated to the other tyre.

In other words, the first tyre 2a passes through the work area 25, 26, 27 without staying in the second work station 13b, 14b, 14d; the second tyre 2b in turn passes through the work area 25, 26, 27 without staying in the first work station 13a, 14a, 14c.

At least in the work stations 15, 16 outside the work areas 25, 26, 27, the robotised arms 17 or other transfer devices operate in accordance with a predetermined cycle time of the plant, in the course of which the tyre 2a, 2b reaches the respective work station 15, 16, undergoes the respective processing and is removed from the work station itself.

At each work area 25, 26, 27, the period of stay of each tyre 2a, 2b in the respective first or second work station 13, 14 can instead be advantageously greater than the cycle time, or at least greater than the period of stay of the tyre itself in each of the work stations 15, 16 outside each work area 25, 26, 27.

Indeed, in each work area 25, 26, 27 each tyre being processed can stay in the respective work station 13, 14, according to a period of time at least equal to a multiple of the period of stay of each tyre 2a, 2b in the work stations 15, 16 outside the work area 25, 26, 27. More particularly, the time it takes each tyre 2a, 2b to cross the work area 25, 26, 27 is substantially equivalent to n times the crossing time of the single work stations 15, 16 outside each work area 25, 26, 27, where n is the number of tyres simultaneously present in the same work area 25, 26, 27, i.e. the number of work stations present in each work area 25, 26 and 27.

In a particular case, in each work area 25, 26, 27, each tyre being processed can stay in the respective work station 13, 14, for a period of time equal to a multiple of the cycle time.

In the case in which, as in the illustrated embodiments, two work stations 13, 14 are provided inside each work area 25, 26, 27, each station arranged to simultaneously receive respective tyres, the crossing time or stay time of each tyre 2a, 2b inside the work area 25, 26, 27 will for example be substantially equal to double the crossing time or stay time in at least one of the work stations 15, 16 outside the work areas 25, 26, 27, summed with the time required for the handling by the robotised arms 17 or other transfer devices for the purpose of loading and/or removing the tyre 2a, 2b itself from the external work station 15, 16.

The prolonged stay of the tyre being processed 2a, 2b inside the work area 25, 26, 27 therefore allows a more accurate performance of processes for which the time available in the external work stations 15, 16 would be insufficient or in any case critically limited.

Finally, the processing of each tyre 2a, 2b in the respective work station 13, 14, integrated in the work area 25, 26, 27, can advantageously comprise the application of two or more components in succession of said tyre 2a, 2b. The time available for the application in succession of the same components in respective work stations 15, 16 outside the work area 25, 26, 27 would be negatively affected by the handling times for transferring the tyre 2a, 2b from one station to another by the transfer devices. On the contrary, the performance of the successive processes on a same work station 13, 14, integrated in the work area 25, 26, 27, eliminates a significant part of the transfer dead times, increasing the time actually available for the processing.

Upon reaching each of the work areas 25, 26, 27, upon action of the robotised arms 17 or other transfer devices, a first tyre being processed 2a is picked up by the work station 15, 16 upstream of the work area 25, 26, 27 and transferred into the first work station 13a, 14a, 14c integrated in the work area itself. Subsequently, a second tyre being processed 2b is picked up from the work station 15, 16 upstream of the work area 25, 26, 27 and transferred into the second work station 13b, 14b, 14d integrated in the area itself. The transfer of the second tyre 2b into the second work station 13b, 14b, 14d occurs when the processing of the first tyre 2a in the first work station 13a, 14a, 14c has not yet been completed.

Therefore, in a same instant, two tyres being processed 2a, 2b simultaneously stay in the ply deposition area 25 during the performance of part, respectively initial and final, of the respective processes.

As represented in FIG. 1, the ply deposition area 25 can for example be preceded by a liner processing station 15a, set for the formation of the liner 5 on each building drum 19a, 19b. A bead processing station 15b can be further arranged downstream of the ply deposition area 25 in order to apply the annular reinforcing structures 6. In a possible additional external work station, not depicted, arranged for example downstream of the bead processing station 15b, the application of the sidewalls 11 or of the radially inner portions 11a thereof can be performed. A first robotised arm 17a or handling device of another type schematically depicted, making up part of the transfer devices 17, picks up a first empty building drum 19a from the assembly unit 24 or from a building drum storage (not illustrated), in order to subject it to the processing in the liner work station 15a, initiating the building of a first tyre being processed 2a. At the end of the respective processing, the building drum 19a carrying the first tyre being processed 2a can be deposited on a first waiting station 28, in order to be picked up by a second robotised arm 17b subordinated to the ply deposition area 25. The first tyre 2a is loaded on the first ply work station 13a, which provides for applying the first carcass ply 4a and subsequently the second carcass ply 4b. Before the processing on the first ply work station 13a is completed, the second robotised arm 17b picks up a second tyre being processed 2b, which in the meantime has been arranged on the waiting station 28.

The second tyre being processed 2b is loaded in the second ply work station 13b integrated in the ply deposition area 25, in order to initiate the application of the respective first and second carcass ply 4a, 4b, when the application of the first or second carcass ply 4a, 4b on the first tyre 2a is still being performed in the first ply work station 13a. The ply work stations 13a, 13b can be aligned along the building line 12, and preferably laterally arranged with respect to a direction of alignment between a position for the input and a position for the output of the tyres being processed 2a, 2b from ply deposition area 25.

More particularly, the second ply work station 13b can be situated downstream of the first ply work station 13a, with reference to the direction of movement of the tyres along the building line 12 or, more particularly, along the carcass structure building path 18. It follows that, in the movement along the building line 12, the second tyre 2b actuates a temporary “overtaking” of the first tyre 2a, situated in the first ply work station 13a. The removal of the first tyre 2a from the ply deposition area 25 will end the temporary overtaking completed by the second tyre 2b, determining the output sequence of the first and second tyre 2a, 2b in accordance with the input sequence of the same in the same ply deposition area 25.

Each tyre 2a, 2b removed from the ply deposition area 25 can be situated in a second waiting station 29 in order to be picked up therefrom upon action of a third robotised arm 17c, which transfers it into the bead work station 15b. A fourth robotised arm 17d picks up the single tyres being processed 2a, 2b from the bead work station 15b in order to transfer it, together with the respective building drum 19a, 19b, into the assembly unit 24 where the coupling occurs with the crown structure 22 formed along the crown structure building path 20.

In the crown structure building path 20, the belt deposition area 26 can be preceded by an underlayer work station 16a adapted to form an under-belt layer (not depicted) on each auxiliary drum 21a, 21b. An auxiliary work station 16b can be arranged between the belt deposition area 26 and the tread band deposition area 27, in order to form an auxiliary belt layer, e.g. of the type commonly termed “0 layer°” (not depicted).

Simultaneously with the processing described with reference to the carcass structure building path 18, the handling device 23 removes a first empty auxiliary drum 21a from the assembly unit 24 or from an auxiliary drum storage (not illustrated), in order to subject it to the processing in the underlayer work station 16a, initiating the building of the crown structure 22 belonging to the first tyre being processed 2a. At the end of the respective processing, the first auxiliary drum 21a carrying the underlayer of the first tyre being processed 2a can be deposited on a third waiting station 40, in order to be picked up by a fifth robotised arm 17e subordinated to the belt deposition area 26.

The first auxiliary drum 21a is loaded on the first belt layer work station 14a which applies the first belt layer 8a and subsequently the second belt layer 8b of the first tyre being processed 2a. Before the processing is completed on the first belt layer work station 14a, the fifth robotised arm 17e picks up a second auxiliary drum 21b carrying the underlayer of the second tyre being processed 2b, which at the same time has been arranged on the third waiting station 30.

The second auxiliary drum 21b is loaded in the second belt layer work station 14b integrated in the belt deposition area 26, in order to initiate the application of the respective first belt layer 8a and second belt layer 8b, when, on the first belt layer work station 14a, application of the first belt layer 8a and/or the second belt layer 8b of the first tyre 2a is still being performed.

The removal of the first auxiliary drum 21a and the second auxiliary drum 21b from the belt deposition area 26 will occur upon action of a sixth robotised arm 17f, according to the output sequence in accordance with the input sequence.

The belt layer work stations 14a, 14b can be symmetrically arranged with respect to a direction of alignment between a position for the input and a position for the output of the tyres being processed 2a, 2b from the belt deposition area 26.

Each tyre being processed 2a, 2b removed from the belt deposition area 26 is subjected to the action of the auxiliary work station 16b, which forms the abovementioned layer at 0°, in order to then be placed in a fourth waiting station 31, possibly arranged on a first linear translator 32 arranged to transfer the single auxiliary drums 21a, 21b to a second linear translator 33 associated with the tread band deposition area 27.

The second linear translator 33 receives the first auxiliary drum 21a carrying the belt layers 8a, 8b of the first tyre being processed 2a into a first waiting position 34. A seventh robotised arm 17g picks up the first auxiliary drum 21a from the first waiting position 34, in order to bring it into the first tread band work station 14c inside the tread band deposition area 27. Upon action of the second linear translator 33, the second auxiliary drum 21b, loaded in the first waiting position 34, is in turn conducted into a second waiting position 35, from which it is adapted to be picked up by the eighth robotised arm 17h in order to be transferred into the second tread band work station 14d, before the first tread band work station 14c has completed the processing on the first auxiliary drum 21a.

Once the production of the respective tread band 9 has been completed, the first auxiliary drum 21a is repositioned in the first waiting position 34 and transferred to the second waiting position 35 upon command of the second linear translator 33, in order to be picked up by the handling device 23. Subsequently, the second auxiliary drum 21b is directly repositioned in the second waiting position 35 upon action of the eighth robotised arm 17h.

The auxiliary drums 21a, 21b separately picked up by the second waiting position 35 upon action of the handling device 23, each together with the respective crown structure 22, are sequentially transferred into the assembly unit 24 where each crown structure 22 is coupled with a respective carcass structure 3 formed along the carcass structure building path 12, for the purpose of completing the first and second tyre 2a, 2b being processed.

1-25. (canceled)

26. A method for building a tyre, wherein a plurality of tyres being processed simultaneously pass along a building line, each tyre to be subjected to a plurality of processes, each in a respective work station, wherein along the building line at least one first and one second tyre being processed reach a work area at different times according to an input sequence, stay in the work area, simultaneously in respective work stations adapted to perform respective homologous processes on said tyres being processed, and leave the work area at different times,
wherein the first and the second tyre being processed stay respectively in at least one first work station and at least one second work station both integrated in the work area; and
wherein the first tyre passes through the work area without staying in said at least one second work station, and the second tyre passes through the work area without staying in said at least one first work station.

27. The method as claimed in claim 26, wherein the first tyre is picked up from a work station upstream of the work area and transferred to said at least one first work station, and the second tyre is picked up from the work station upstream of the work area and transferred to said at least one second work station.

28. The method as claimed in claim 26, wherein the tyres being processed leave the work area according to an output sequence identical to the input sequence.

29. The method as claimed in claim 26, wherein, upon reaching the respective work stations integrated in the work area, each of the tyres being processed carries the same components.

30. The method as claimed in claim 26, wherein, in the work area, each of the tyres being processed remains in a respective work station integrated in the work area according to a period of time greater than a period of stay of each tyre in work stations outside the work area.

31. The method as claimed in claim 26, wherein said tyres being processed are simultaneously moved through work stations distributed in sequence along the building line.

32. The method as claimed in claim 26, wherein the second tyre being processed which reaches the work area is loaded in the second work station downstream of the first work station carrying the first tyre previously introduced into the work area.

33. The method as claimed in claim 26, wherein two tyres being processed simultaneously stay in the work area during a performance of part, respectively initial and final, of the respective processes.

34. The method as claimed in claim 26, wherein each of the tyres being processed in the work area remains in a respective work station integrated in the work area according to a period of time substantially equivalent to a multiple of a period of stay of each tyre in work stations outside the work area.

35. The method as claimed in claim 26, wherein each tyre crosses the work area in a crossing time substantially equivalent to n times a crossing time of at least one work station outside the work area, where n is the number of work stations integrated in the work area.

36. The method as claimed in claim 26, wherein, in the work area, each of the tyres stays in a respective work station integrated in the work area.

37. The method as claimed in claim 26, wherein the processing of each tyre in the respective work station integrated in the work area comprises the application of two or more components of said tyre.

38. The method as claimed in claim 26, wherein, in each of the work stations integrated in the work area, there is performed the application of a first belt layer and a second belt layer of a tyre being processed.

39. The method as claimed in claim 26, wherein, in each of the work stations integrated in the work area, there is performed the application of a first carcass ply and a second carcass ply of a tyre being processed.

40. The method as claimed in claim 26, wherein, in each of the work stations integrated in the work area, there is performed the application of a first and a second portion of a tread band of a tyre being processed.

41. A plant for building tyres, comprising:
a plurality of work stations distributed in sequence along a building line;
transfer devices for transferring tyres being processed between subsequent work stations,
further comprising at least one work area wherein at least one first and at least one second of said work stations perform simultaneously homologous processes with respect to each other, respectively on a first and a second tyre being processed respectively consecutive along the building line, and
wherein said transfer devices transfer the first and the second tyre through the work area without the first tyre staying in said at least one second work station, and without the second tyre staying in said at least one first work station.

42. The plant as claimed in claim 41, wherein said transfer devices pick up the first tyre coming from a work station upstream of the work area for transferring said first tyre to said at least one first work station, and pick up the second tyre coming from the work station upstream of the work area for transferring the second tyre to said at least one second work station.

43. The plant as claimed in claim 41, wherein the transfer devices pick up the first and the second tyre being processed from the work area according to an output sequence identical to an input sequence of the same tyres in the work area.

44. The plant as claimed in claim 41, wherein the work stations integrated in said work area are aligned along the building line.

45. The plant as claimed in claim 41, wherein the work stations integrated in said work area are arranged symmetrically with respect to a direction of alignment between a position for the input and a position for the output of the tyres being processed from the work area.

46. The plant as claimed in claim 41, wherein the work stations integrated in said work area are arranged laterally with respect to a direction of alignment between a position for the input and a position for the output of the tyres being processed from the work area.

47. The plant as claimed in claim 41, wherein each work station integrated in the work area comprises devices for applying a first and a second component of said tyre being processed.

48. The plant as claimed in claim 41, wherein each work station integrated in the work area comprises devices for applying a first belt layer and a second belt layer of said tyre being processed.

49. The plant as claimed in claim 41, wherein each work station integrated in the work area comprises devices for applying a first carcass ply and a second carcass ply of said tyre being processed.

50. The plant as claimed in claim 41, wherein each work station integrated in the work area comprises devices for applying a first and a second portion of a tread band of said tyre being processed.
